(19) United States
(12) Patent Application Publication
(10) Pub. No.: US 2026/0255371 A1
(43) Pub. Date: Aug. 27, 2026

(54) METHOD AND APPARATUS FOR SYNCHRONIZATION SIGNAL TRANSMISSION AND LBT FAILURE INDICATION OF SL-U IN MOBILE COMMUNICATIONS

(71) Applicant: MediaTek Singapore Pte. Ltd., Singapore (SG)

(72) Inventors: Junqiang CHENG, Beijing (CN); Tao CHEN, Beijing (CN); Ming-Yuan CHENG, Hsinchu City (TW)

(21) Appl. No.: 19/160,234

(22) PCT Filed: Mar. 20, 2024
(86) PCT No.: PCT/CN2024/082702

§ 371 Date: Aug. 27, 2025

(30) Foreign Application Priority Data
Apr. 7, 2023 (WO) PCT/CN2023/087068

(51) Int. Cl. H04W 72/25; H04W 72/40; H04W 74/0808

(52) U.S. Cl. CPC H04W 72/25; H04W 72/40; H04W 74/0808

(57) ABSTRACT

Examples pertaining to synchronization signal transmission in mobile communications are described. A user equipment (UE) obtains a configuration of a number of additional candidate sidelink synchronization signal block (S-SSB) occasions and a gap. The UE determines at least one additional candidate S-SSB occasion according to the configuration. The UE determines whether to transmit at least one additional S-SSB in the at least one additional candidate S-SSB occasion.

### CROSS REFERENCE TO RELATED PATENT APPLICATION(S)

The present disclosure is part of a non-provisional application claiming the priority benefit of PCT Application No. PCT/CN2023/087068, filed 7 Apr. 2023, the content of which herein being incorporated by reference in its entirety.

### TECHNICAL FIELD

The present disclosure is generally related to mobile communications and, more particularly, to synchronization signal transmission and the associated listen before talk (LBT) failure indication in mobile communications.

### BACKGROUND

Unless otherwise indicated herein, approaches described in this section are not prior art to the claims listed below and are not admitted as prior art by inclusion in this section.

In fifth generation (5G) New Radio (NR), a study item on sidelink (SL) transmission on unlicensed band (or unlicensed spectrum) (SL-U) has been triggered. The sidelink is also known as direct communication or device-to-device (D2D) communication. The use of unlicensed spectrum is governed by various requirements. One such requirement is a Listen Before Talk (LBT) mechanism to ensure that a channel is free before it can be used by a device. SL-U applies an LBT mechanism for channel access to unlicensed spectrum.

LBT is performed by a device by sensing the channel for a period of time. The device monitors the channel for a time period to check if it is free or available for use. If the energy detected in the channel is higher than a predetermined threshold, the channel is deemed to be busy and the device cannot use the channel for a transmission, i.e. LBT has failed. If the energy detected in the channel is lower than a predetermined threshold for a period of time, the channel is deemed to be free/available and can be used by the device for its transmission, i.e. LBT is successful. In case of an LBT failure, the device may continue monitoring the channel for a period of time to determine when the channel is free/available to be accessed.

In case several devices are operating on the same unlicensed channel, the chances of LBT failure could become higher due to higher occupancy of the channel by the devices operating on the same channel. Operation in a busy unlicensed channel reduces the probability of the devices being able to communicate with other devices.

Accordingly, how to avoid unreachable status between devices due to busy channels becomes an important issue for unlicensed band access in the newly developed wireless communication network. Therefore, it is needed to provide proper mechanisms to handle LBT failures for synchronization signal transmission and the associated LBT failure indication of SL-U in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to synchronization signal transmission and the associated LBT failure indication of SL-U in mobile communications.

In one aspect, a method may involve an apparatus obtaining a configuration of a number of additional candidate sidelink synchronization signal block (S-SSB) occasions and a gap, determining at least one additional candidate S-SSB occasion according to the configuration and determining whether to transmit at least one additional S-SSB in the at least one additional candidate S-SSB occasion.

In one aspect, a method may involve an apparatus triggering a sidelink (SL) consistent listen before talk (LBT) (C-LBT) failure in an event that a plurality of SL LBT failures have occurred in an active resource block (RB) set and selecting another RB set in which the SL C-LBT failure has not been triggered.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of synchronization signal transmission method in SL-U in accordance with an implementation of the present disclosure.

FIG. 2 is a diagram depicting an example scenario of LBT failure indication between different layers of the protocol stack of an apparatus and the corresponding operations performed by the layers in accordance with an implementation of the present disclosure.

FIG. 3 is a diagram depicting an example scenario of a hierarchy of radio resources methods for interlace and sub-channel indexing across different resource pools in accordance with an implementation of the present disclosure.

FIG. 4 is a diagram depicting an example communication system having an example communication apparatus and an example network apparatus in accordance with an implementation of the present disclosure.

FIG. 5 is a diagram depicting an example process in accordance with an implementation of the present disclosure.

FIG. 6 is a diagram depicting an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to synchronization signal transmission and the associated LBT failure indication of the SL-U. According to the present disclosure, a number of possible solutions may be implemented separately or jointly. That is, although these possible solutions may be described below separately, two or more of these possible solutions may be implemented in one combination or another.

For the SL-U, a potential channel access (e.g., LBT) failure will block the transmission and may degrade the system performance. For example, the LBT failure before synchronization signal (e.g., a sidelink synchronization signal block (S-SSB)) will block the normal transmission of S-SSB signal, and further result in synchronization problem of the system.

To solve the problem, in one aspect of the present disclosure, one or more additional candidate S-SSB occasions may be configured or preconfigured to compensate the potential channel access failure before a legacy S-SSB occasion (e.g., the S-SSB occasion defined in the third generation Partnership Project (3GPP) Release 16 (R16 ) or Release 17 (R17)).

In some implementations, an S-SSB occasion may be configured or preconfigured with K corresponding additional candidate S-SSB occasion(s), where K is an integer. Alternatively, in some implementations, a total number of S-SSB occasion (including the legacy S-SSB occasion and the one or more additional candidate S-SSB occasion(s)) may be configured or preconfigured, and the total number (e.g., N) may be defined by a radio resource control (RRC) parameter for each numerology, where N is a positive integer.

In some implementations, each NR SL S-SSB slot (e.g., the aforementioned S-SSB occasion) may has K corresponding additional candidate S-SSB occasion(s) in different time slot(s), and the gap between them may be configured, preconfigured or indicated.

In some implementations, the number of additional candidate S-SSB occasion(s) may be configured, preconfigured or indicated from a range. In some implementations, the location (e.g., the gap) of the additional candidate S-SSB occasion(s) may be configured, preconfigured or indicated from a range.

In some implementations, an apparatus (e.g., a user equipment (UE) or a SL device) may obtain a configuration of a number of additional candidate S-SSB occasion(s) and a gap. In some implementations, the number may be a predefined set of values, such as but not limited to {0, 1, 2, 3, 4}. The UE may be a transmitter UE (TX-UE) to transmit a synchronization signal to a receiver UE (RX-UE). In some implementations, the UE may determine at least one additional candidate S-SSB occasion according to the configuration and determine whether to transmit at least one additional S-SSB in the at least one additional candidate S-SSB occasion. In some implementations, whether to transmit an additional S-SSB may depend on the UE's implementation. In some implementations, the at least one additional S-SSB is transmitted in a sidelink unlicensed band, as the normal transmission of S-SSB signal.

In some implementations, the configuration may be obtained or received from a network apparatus (e.g., a network node or a base station (BS), such as a next generation Node B (gNB)), obtained or received from another apparatus (e.g., a device supporting or implementing the sidelink application) or pre-stored in a memory of the apparatus (e.g., the UE).

In some implementations, the configuration may be signaled by system information block (SIB), RRC or SL-RRC signaling, medium access control (MAC) control element (CE) (MAC-CE), or sidelink control information (SCI).

In some implementations, the configured number and the corresponding location(s) of the one or more additional candidate S-SSB occasions may be obtained or determined when the UE determines the at least one additional candidate S-SSB occasion according to the configuration.

In some implementations, the gap may indicate a first gap (e.g., the gap Gap_1) between an S-SSB slot (e.g., the aforementioned S-SSB occasion) and a first additional candidate S-SSB occasion or a second gap (e.g., the gap Gap_2) between two adjacent additional candidate S-SSB occasions.

In some implementations, the second gap may be fixed to or equal to the first gap.

In some implementations, the UE (e.g., the TX-UE) may transmit information regarding the at least one additional candidate S-SSB occasion to a peer apparatus (e.g., the RX-UE).

In some implementations, the UE (e.g., the TX-UE) may transmit information regarding the configuration of the number of additional candidate S-SSB occasion(s) and the gap to the peer apparatus (e.g., the RX-UE).

In some implementations, the at least one additional SSB may be transmitted in an event that no S-SSB is transmitted in the S-SSB slot or an LBT failure occurs.

In some implementations, the at least one additional SSB may be transmitted in an event that an S-SSB is transmitted in an S-SSB slot or an LBT success occurs.

In some implementations, the number of additional candidate S-SSB occasions may be configured per sidelink bandwidth part (SL-BWP).

In some implementations, the number of additional candidate S-SSB occasions may be determined from a predefined set of values, such as but not limited to the aforementioned predefined set of values {0, 1, 2, 3, 4}.

In some implementations, the number (e.g., the number K) may be configured or preconfigured per SL-BWP from the predefined set of values. For example, the UE may determine or be configured with one value which is selected from the predefined set as the number K for a corresponding S-SSB slot. Note that when K=0, there may be no additional candidate S-SSB occasion configured for the corresponding S-SSB slot.

In some implementations, the gap may be configured per SL-BWP.

In some implementations, the gap may be determined from a predefined number of slots.

In some implementations, the gap (e.g., the gap Gap_1) may be configured or preconfigured per SL-BWP from {0, 1, 2, 3, 4, . . . , 639} slots under the numerology of 15 Kilohertz (KHz).

In some implementations, the number of additional candidate S-SSB occasions may be configured per S-SSB period. In some implementations, in additional to the R16 or R17 S-SSB occasions, one or more additional candidate S-SSB occasions per period (e.g., S-SSB period) is supported.

In some implementations, different from having only one slot or one occasion for S-SSB transmission in one S-SSB period in legacy design, a plurality of (e.g., (K+1)) slots or occasions may be scheduled, configured or arranged in one S-SSB period for possible or intended S-SSB transmission.

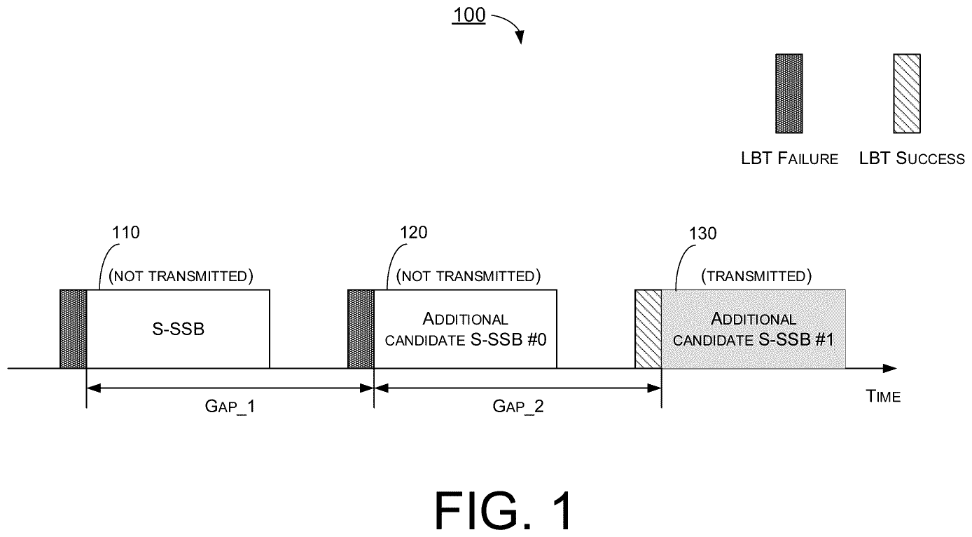

FIG. 1 illustrates an example scenario 100 of synchronization signal transmission method in SL-U in accordance with an implementation of the present disclosure. The S-SSB occasion 110 may be the aforementioned legacy S-SSB occasion, that is, an NR SL S-SSB slot.

In some implementations, one or more additional candidate S-SSB occasions corresponding to the S-SSB occasion 110 may be configured or preconfigured. The S-SSB occasion 120 may be the first additional candidate S-SSB occasion (denoted as ‘Additional candidate S-SSB #0’ in FIG. 1). The S-SSB occasion 130 may be the second additional candidate S-SSB occasion (denoted as ‘Additional candidate S-SSB #1’ in FIG. 1).

Assuming that the LBT (i.e., channel access) performed before the S-SSB occasion 110 has failed (denoted by the pattern of ‘LBT failure’ in FIG. 1), no S-SSB is transmitted (denoted as ‘not transmitted’ in FIG. 1) in the S-SSB occasion 110. The UE may continue monitoring the channel for implementing the LBT.

Assuming that the LBT performed before the S-SSB occasion 120 has also failed, no S-SSB is transmitted in the S-SSB occasion 120 as well. The UE may continue monitoring the channel for implementing the LBT.

Assuming that the LBT performed before the S-SSB occasion 130 is successful (denoted by the pattern of 'LBT success in FIG. 1), an S-SSB is transmitted (denoted as ‘transmitted’ in FIG. 1) in the S-SSB occasion 130. The S-SSB transmitted in the S-SSB occasion 130 may be an additional S-SSB as it is transmitted in an additional candidate S-SSB occasion. In this manner, the problem of a single transmission occasion of S-SSB signal (e.g., the synchronization signal transmission arranged in the legacy S-SSB occasion) being blocked by the LBT failure can be solved.

In some implementations, the location of the additional candidate S-SSB occasion(s) may be defined or indicated by an offset regarding to the corresponding legacy S-SSB occasion, such as the gap Gap_1. In some implementations, the gap (or the offset) may be configured or preconfigured in the aforementioned configuration or may be dynamically indicated.

In some implementations, the location of the additional candidate S-SSB occasion(s) may be defined by an offset regarding to a previous adjacent S-SSB occasion.

As shown in FIG. 1, the gap GAP_1 is the gap between the R16 or R17 NR SL S-SSB slot (e.g., the legacy S-SSB slot) and its 1st corresponding additional candidate S-SSB occasion and the gap Gap_2 is the gap between any two adjacent additional candidate S-SSB occasions corresponding to the legacy S-SSB slot when K>1. In some implementations, the gap Gap_2 may be fixed to or equal to the gap GAP_1.

In some implementations, in the same S-SSB period, the UE may attempt to transmit on additional candidate S-SSB occasion(s) regardless of whether or not an S-SSB has been transmitted on the R16 or R17 S-SSB occasion(s).

In some implementations, for synchronization signal transmitted in frequency range 1 (FR1), the S-SSB transmitted in any additional S-SSB occasion may be regarded as a duplication or a replacement of an S-SSB supposed to be transmitted in a legacy S-SSB occasion, or may be regarded as an additional S-SSB. For synchronization signal transmitted in FR2, or transmitted based on the manner of beam, each legacy S-SSB occasion may be associated with a specific beam, a channel state information reference signal (CSI-RS), a direction or an average gain. In this case, only the additional candidate S-SSB occasion(s) associated with the same beam, CSI-RS, direction or average gain may be regarded as the duplication or replacement of the corresponding legacy S-SSB occasion. In other words, only the additional candidate S-SSB occasion(s) that have quasi co-location (QCL) relation may be regarded as the duplication or replacement of the corresponding QCLed legacy S-SSB occasion.

In some implementations, regarding the UE to receive the S-SSB (e.g., the RX-UE), the UE may attempt to receive the S-SSB in the corresponding slot(s) or occasion(s) based on the information regarding the at least one additional candidate S-SSB occasion. In some implementations, the UE may attempt to receive the S-SSB in the corresponding slot(s) or occasion(s) based on the configuration of the number of additional candidate S-SSB occasion(s) and the gap. In some implementations, the UE may attempt to receive the S-SSB until at least one S-SSB is successfully received.

In some implementations, the UE may stop receiving the S-SSB in an event that an S-SSB is successfully received. In some implementations, the UE may attempt to receive the S-SSB in the corresponding slot(s) or occasion(s) regardless of whether or not an S-SSB is successfully received.

In another aspect of the present disclosure, methods for LBT failure indication are introduced. Different from the 5G NR in unlicensed spectrum (NR-U) that one UE may only communicate with one gNB in a duration, in SL-U, a UE may maintain multiple links with different UE. Besides, a UE may perform beam based LBT (i.e., channel access) for the case that transmitted on the spectrum of FR2. In these cases, methods for LBT failure indication and granularity of the LBT failure indication in SL-U have to be reconsidered. Additionally, the corresponding radio link failure (RLF) failure declaration and the potential resource selection or reselection triggered by LBT failure indication in SL-U also have to be redesigned.

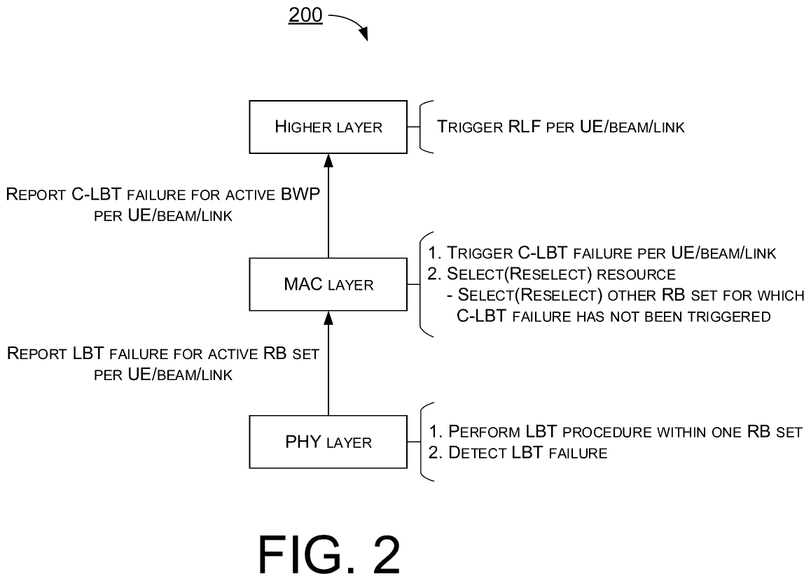

FIG. 2 illustrates an example scenario 200 of LBT failure indication between different layers of the protocol stack of an apparatus (e.g., a UE or a SL device) and the corresponding operations performed by the layers in accordance with an implementation of the present disclosure.

In some implementations, the layers of the protocol stack, such as the physical layer (i.e., layer 1) (denoted as ‘PHY layer’ in FIG. 2), the medium access control layer (denoted as ‘MAC layer’ in FIG. 2) and one or more higher layers (denoted as ‘Higher layer’ in FIG. 2) may be implemented by hardware circuits or hardware devices, and/or may be implemented by firmware or software programs. In addition, these layers may also be different entities, and at least a portion of the layers may be the entities (e.g., implemented by software and/or hardware) of a processor of the apparatus. For example, the ‘MAC layer’ in FIG. 2 may be a MAC entity of the processor, and the ‘PHY layer’ in FIG. 2 may be a physical layer (i.e., layer 1) entity or a physical layer circuit of the processor or of the apparatus. Note that the physical layer circuit is not limited to be implemented fully inside the processor of the apparatus. That is, the physical layer circuit may comprise one or more components or sub-circuits inside of the processor and may comprise one or more components or sub-circuits configured outside of the processor.

In some implementations, in a scenario of SL-U, an LBT (e.g., channel access) procedures is performed by the physical layer (or the physical layer circuit or entity) before the UE to start transmission on the channel. For example, the physical layer may perform an LBT procedure within one RB set. In an event that the UE detects an LBT failure event prior to an intended SL transmission to another UE, the physical layer may report the LBT failure (i.e., SL LBT failure) for an active resource block (RB) set to a higher layer, such as the ‘MAC layer’ in FIG. 2. For example, the physical layer may transmit an LBT failure indication to the MAC layer to notify the MAC layer about the LBT failure (i.e., channel access failure).

In some implementations, the LBT failure may be reported or indicated per UE. In some implementations, the LBT failure may be reported or indicated per UE if no additional configuration, reconfiguration or indication. In some implementations, the UE may determine an SL LBT failure per SL RB set or per active RB set. That is, the SL LBT failure indication granularity may be per SL RB set or per active RB set. In some implementations, the physical layer may determine at least one of the SL LBT failures per SL RB set or per active RB set.

In some implementations, for the case that the SL LBT failure is reported or indicated per UE, the SL LBT failure may be applied to all links of the apparatus.

Additionally, for the case that a UE maintains multiple links with other UE(s) (e.g., by the way of time division multiplexing (TDM)), the granularity of LBT failure indication may be configured, preconfigured or indicated per link. For the case that the LBT failure indication is reported or indicated per link, an additional signaling may be added to indicate the link index. For example, the identity (ID) (e.g., destination ID) of each link may be indicated together with the corresponding LBT failure indication.

Additionally, for the case that the transmission is beam based (e.g., transmitted on the spectrum of FR2), the LBT failure indication may be configured, preconfigured or indicated per beam. For the case that the LBT failure indication is reported or indicated per beam, an additional signaling may be added to indicate the beam index. For example, the beam index or ID, or CSI-RS resource indicator of each beam may be indicated together with the corresponding LBT failure indication.

Regarding the MAC layer operations, in some implementations, a consistent LBT (C-LBT) failure (i.e., an SL C-LBT failure) may be triggered per UE in an event that a plurality of SL LBT failures have occurred in the active RB set. In some implementations, the C-LBT failure may be triggered or detected per RB set or per resource pool (RP), by counting the number of LBT failure indications for all SL transmissions from the lower layer to the MAC entity. If the counted number of LBT failure indications meets a configured or preconfigured condition, the C-LBT failure is triggered for the active SL RB set.

To be more specific, in some implementations, the MAC entity (or MAC layer) may start a timer and increase an LBT counter in an event that consistent SL LBT failure is detected. The MAC entity may determine whether the LBT counter reaches a threshold value and determine an SL C-LBT failure event in an event that the LBT counter reaches the threshold value before the timer expires. The SL C-LBT failure is detected when the SL C-LBT failure event is determined (i.e., determined to have occurred).

In some implementations, for the case that the SL C-LBT failure is triggered per UE, the SL C-LBT failure may be applied to all links of the apparatus.

In some implementations, in an event that the C-LBT failure is triggered or detected, the MAC entity/layer may transmit information of an RB set that the SL C-LBT failure was detected to the physical entity/layer.

In some implementations, in an event that the C-LBT failure is triggered or detected, the MAC entity may further select another RB set in which the SL C-LBT failure has not been triggered. In some implementations, the C-LBT failure may be triggered for the active RB set.

In some implementations, the MAC entity may switch the active SL RB set to an SL RB set (or reselect an SL RB set) in the same RP or on the same BWP, for which C-LBT failure has not been triggered. Alternatively, the MAC entity may reselect an SL resource (e.g., other slots) within the same RB set. The granularity of the C-LBT failure triggered by MAC entity may be aligned with the granularity of LBT failure indication from the physical layer.

In some implementations, in an event that the SL LBT failure granularity is per RB set, the change, selection or reselection of RB set of which SL C-LBT failure has not been triggered upon C-LBT failure detection is supported. In some implementations, in an event that the SL LBT failure granularity is per RP, the change, selection or reselection of RP of which SL C-LBT failure has not been triggered upon C-LBT failure detection is supported.

In some implementations, exclusion of RB set(s) that the SL C-LBT failure was detected in candidate resource selection and RP selection or reselection may be supported. In some implementations, the UE may perform resource exclusion for an RB set that the SL C-LBT failure was detected in a candidate resource selection or an RP selection or reselection. In some implementations, the resource exclusion may be performed by the physical layer of the apparatus.

In some implementations, for the case that the C-LBT failure has been triggered in all SL RB sets on same RP, the MAC entity may select or reselect another RP, for which the C-LBT failure has not been triggered. In some implementations, for the case that the C-LBT failure has been triggered in all RPs on the same BWP, the MAC entity may report or indicate consistent LBT failure for active BWP to the upper layers.

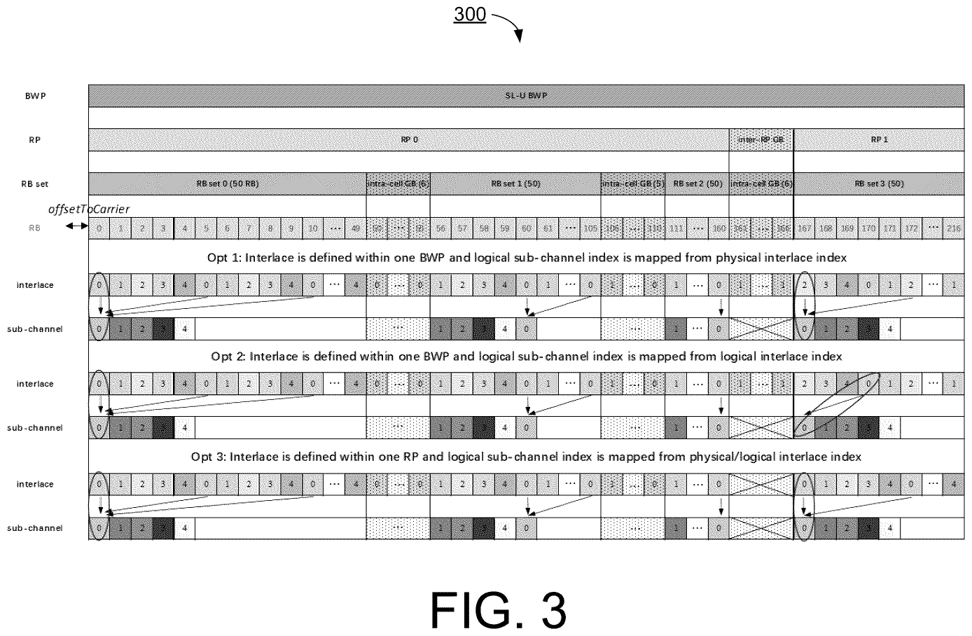

FIG. 3 illustrates an example scenario 300 of a hierarchy of radio resources RBs, RB sets and RPs within an SL-U BWP and methods for interlace and sub-channel indexing across different resource pools in accordance with an implementation of the present disclosure. In the example scenario 300, there are two resource pools, such as the RP 0 and RP 1 in FIG. 3, comprised in the SL-U BWP and an inter RP guard band (denoted as ‘inter-RP GB’ in FIG. 3) between the resource pools. The RB sets are numbered from 0 across all RPs. The resource pool RP 0 may comprise three RB sets, such as the RB set 0, RB set 1 and RB set 2 in FIG. 3 and intra cell guard bands (denoted as ‘intra-cell GB’ in FIG. 3) between two RB sets. The resource pool RP 1 may comprise one RB set, such as the RB set 3 in FIG. 3. Each RB set may correspond to a plurality of RBs.

In some implementations, the sub-channel is indexed across multiple RPs. FIG. 3 shows three options of interlace, and the terms of logical and physical in the options are stated from the perspective of logical index and physical location, respectively. In some implementations, interlace may be defined within one SL BWP, and logical sub-channel index (i.e., sub-channel #0) may be mapped from physical interlace index (the 1st interlace regarding physical location, i.e., interlace #2 in Option 1). Alternatively, interlace may be defined within one BWP and logical sub-channel index (i.e., sub-channel #0) may be mapped from logical interlace index (i.e., interlace #0 in Option 2). Alternatively, interlace may be defined within one RP and logical sub-channel index (i.e., sub-channel #0) may be mapped from physical interlace index (the 1st interlace regarding physical location, i.e., interlace #0 in Option 1) or logical interlace index (i.e., interlace #0 in Option 3).

In some implementations with respect to the resource selection or reselection, assuming that an SL C-LBT failure has been triggered in the RB set RB set 0, the MAC entity may select another RB set of which the SL C-LBT failure has not been triggered from the same resource pool, such as the RB set RB set 1 or RB set 2 in the same resource pool RP 0. In some implementations, assuming that the SL C-LBT failure has been triggered in all RB sets in the resource pool RP 0, the MAC entity may select another RB set of which the SL C-LBT failure has not been triggered from another resource pool, such as the RB set RB set 3 in the resource pool RP 1. That is, the UE may perform resource pool selection or reselection in an event that the SL C-LBT failure was detected for all RB sets within a selected resource pool.

In some implementations, in an event that the C-LBT failure is triggered or detected, the MAC layer or MAC entity may also report the C-LBT failure for the active RB set or the active BWP to a higher layer (the ‘Higher layer’ in FIG. 2). For example, the MAC layer may transmit a C-LBT failure indication to the higher layer to notify the higher layer about the C-LBT failure.

In some implementations, the C-LBT failure may be reported or indicated per UE. In some implementations, the C-LBT failure may be reported or indicated per UE if no additional configuration, reconfiguration or indication.

Additionally, for the case that a UE maintains multiple links with other UE(s), the granularity of C-LBT failure indication may be configured, preconfigured or indicated per link. For the case that the C-LBT failure indication is reported or indicated per link, an additional signaling may be added to indicate the link index. For example, the ID (e.g., destination ID) of each link may be indicated together with the corresponding C-LBT failure indication.

Additionally, for the case that the transmission is beam based (e.g., transmitted on the spectrum of FR2), the C-LBT failure indication may be configured, preconfigured or indicated per beam. For the case that the C-LBT failure indication is reported or indicated per beam, an additional signaling may be added to indicate the beam index. For example, the beam index or ID, or CSI-RS resource indicator of each beam may be indicated together with the corresponding C-LBT failure indication.

In some implementations, in an event that all triggered C-LBT failures are cancelled, or in an event that the timer for LBT failure detection expires, or in an event that the timer or the threshold value is reconfigured by higher layers, the LBT counter may be set to 0.

In some implementations, the MAC entity may reset the LBT counter for SL C-LBT failure cancellation in an event that the timer is expired.

In some implementations, the MAC entity may reset the LBT counter for SL C-LBT failure cancellation in an event that the timer or the threshold value is reconfigured.

Regarding the higher layer operations, in some implementations, a radio link failure (RLF) procedure may be triggered for one or more uni-cast (UC) connections in an event that the SL C-LBT failure has been triggered in all RB sets within an SL BWP. That is, the RLF may be declared by the higher layer in an event that the SL C-LBT failure has been triggered in all RB sets within a BWP.

In some implementations, the RLF may be triggered per UE. Additionally, for the case that a UE maintains multiple links with other UE(s), the RLF may be triggered per link. Additionally, for the case that the transmission is beam based, the RLF may be triggered per beam.

In some implementations, the granularity of the RLF declaration may be aligned with the granularity of C-LBT failure triggered by MAC entity. For example, if the C-LBT failure is indicated per UE, per link, or per beam, the RLF is declared per UE, per link, or per beam, respectively. Additionally, for the case the RLF is declared per UE, it means all link(s) or all beam(s) associated with the corresponding UE are declared as RLF. In this case, an additionally signaling shall be added when MAC entity indicates C-LBT failure to the higher layer. For example, the link index and/or destination ID of each link may be added to indicate which link the C-LBT failure is detected. Besides, the beam index or ID or the CSI-RS resource indicator of each beam may be added to indicate which beam the C-LBT failure is detected. Additionally, the resource granularity of RLF trigger may be configured or preconfigured per RP, per SL BWP or per carrier.

Additionally, for higher layers, if C-LBT failure is reported from lower layers, it can trigger RLF per UE, per beam or per link. If the RLF is triggered per resource pool, the higher layers may select or reselect another resource pool for which C-LBT failure has not been triggered. If the RLF is triggered per BWP, the higher layer may select or reselect another carrier if only one BWP is configured in one carrier. Otherwise, the higher layer may select or reselect another BWP on the same carrier.

### Illustrative Implementations

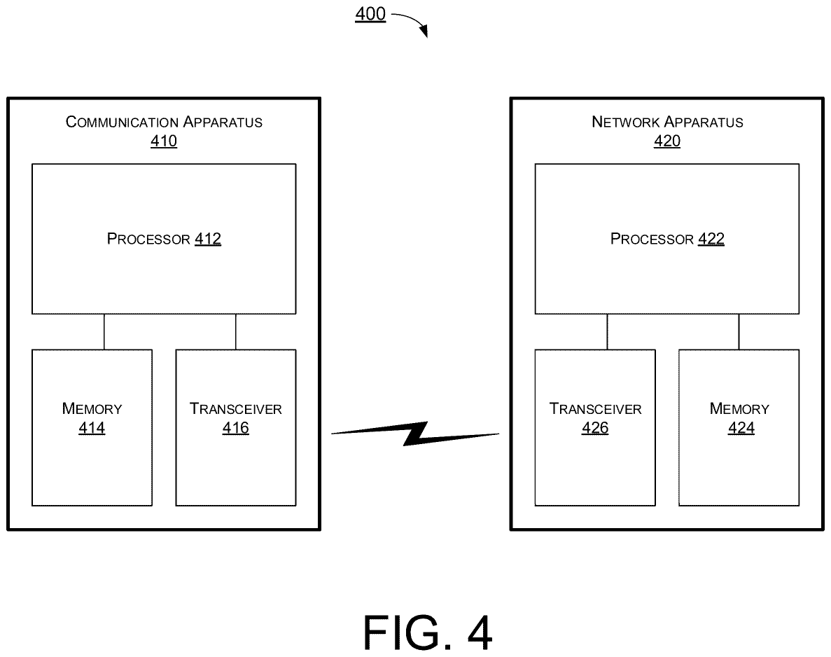

FIG. 4 illustrates an example communication system 400 having an example communication apparatus 410 and an example network apparatus 420 in accordance with an implementation of the present disclosure. Each of the communication apparatus 410 and the network apparatus 420 may perform various functions to implement schemes, techniques, processes and methods described herein pertaining to synchronization signal transmission and the associated LBT failure indication of SL-U in mobile communications, including scenarios/schemes described above as well as the process 500 and the process 600 described below.

The communication apparatus 410 may be a part of an electronic apparatus, which may be a UE such as a portable or mobile apparatus, a wearable apparatus, a wireless communication apparatus or a computing apparatus. For instance, the communication apparatus 410 may be implemented in a smartphone, a smartwatch, a personal digital assistant, a digital camera, or a computing equipment such as a tablet computer, a laptop computer or a notebook computer. The communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 410 may be implemented in a smart thermostat, a smart fridge, a smart door lock, a wireless speaker or a home control center. Alternatively, the communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 410 may include at least some of those components shown in FIG. 4 such as a processor 412, for example. The communication apparatus 410 may further include one or more other components not pertinent to the proposed scheme of the present disclosure (e.g., internal power supply, display device and/or user interface device), and, thus, such component(s) of the communication apparatus 410 are neither shown in FIG. 4 nor described below in the interest of simplicity and brevity.

The network apparatus 420 may be a part of a network device, which may be a network node such as a satellite, a base station, a small cell, a router or a gateway. For instance, the network apparatus 420 may be implemented in an eNodeB in an LTE network, in a gNB in a 5G/NR, IoT, NB-IoT or IIoT network or in a satellite or base station in a 6G network. Alternatively, the network apparatus 420 may be implemented in the form of one or more IC chips such as, for example and without limitation, one or more single-core processors, one or more multi-core processors, or one or more RISC or CISC processors. The network apparatus 420 may include at least some of those components shown in FIG. 4 such as a processor 422, for example. The network apparatus 420 may further include one or more other components not pertinent to the proposed scheme of the present disclosure (e.g., internal power supply, display device and/or user interface device), and, thus, such component(s) of the network apparatus 420 are neither shown in FIG. 4 nor described below in the interest of simplicity and brevity.

Note that in some implementations, the network apparatus 420 may also be implemented as another communication apparatus like the communication apparatus 410 (e.g., a peer communication apparatus communicating with the communication apparatus 410) to implement a sidelink communication or the SL-U communication.

In one aspect, each of the processor 412 and the processor 422 may be implemented in the form of one or more single-core processors, one or more multi-core processors, or one or more CISC processors. That is, even though a singular term “a processor” is used herein to refer to the processor 412 and the processor 422, each of the processor 412 and the processor 422 may include multiple processors in some implementations and a single processor in other implementations in accordance with the present disclosure. In another aspect, each of the processor 412 and the processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 412 and the processor 422 is a special-purpose machine specifically designed, arranged and configured to perform specific tasks including autonomous reliability enhancements in a device (e.g., as represented by the communication apparatus 410) and a network (e.g., as represented by the network apparatus 420) in accordance with various implementations of the present disclosure.

In some implementations, the communication apparatus 410 may also include a transceiver 416 coupled to the processor 412 and capable of wirelessly transmitting and receiving data. In some implementations, the communication apparatus 410 may further include a memory (or non-transitory computer-readable medium) 414 coupled to the processor 412 and capable of being accessed by the processor 412 and storing data therein. In some implementations, the network apparatus 420 may also include a transceiver 426 coupled to the processor 422 and capable of wirelessly transmitting and receiving data. In some implementations, the network apparatus 420 may have a plurality of physical antennas which associates with a plurality of antenna ports. In some implementations, the network apparatus 420 may further include a memory (or non-transitory computer-readable medium) 424 coupled to processor 422 and capable of being accessed by the processor 422 and storing data therein. Accordingly, the communication apparatus 410 and the network apparatus 420 may wirelessly communicate with each other via the transceiver 416 and the transceiver 426, respectively. To aid better understanding, the following description of the operations, functionalities and capabilities of each of the communication apparatus 410 and the network apparatus 420 is provided in the context of a mobile communication environment in which the communication apparatus 410 is implemented in or as a communication apparatus or a UE and the network apparatus 420 is implemented in or as a network node or a network device, or another UE of a communication network.

In one aspect of the present disclosure, the processor 412 of the communication apparatus 410 may obtain a configuration of a number of additional candidate sidelink synchronization signal block (S-SSB) occasions and a gap, determine at least one additional candidate S-SSB occasion according to the configuration and determine whether to transmit, via the transceiver 416, at least one additional S-SSB in the at least one additional candidate S-SSB occasion.

In some implementations, the gap may indicate a first gap between an S-SSB slot and a first additional candidate S-SSB occasion or a second gap between two adjacent additional candidate S-SSB occasions.

In some implementations, the processor 412 may transmit, via the transceiver 416, information regarding the at least one additional candidate S-SSB occasion to a peer apparatus.

In some implementations, the at least one additional SSB may be transmitted in an event that no S-SSB is transmitted in the S-SSB slot or an LBT failure occurs.

In some implementations, the at least one additional SSB may be transmitted in an event that an S-SSB is transmitted in an S-SSB slot or an LBT success occurs.

In some implementations, the number of additional candidate S-SSB occasions and the gap may be configured per SL-BWP.

In some implementations, the number of additional candidate S-SSB occasions may be determined from a predefined set of values.

In some implementations, the gap may be determined from a predefined number of slots.

In some implementations, the second gap may be equal to the first gap.

In some implementations, the number of additional candidate S-SSB occasions may be configured per S-SSB period.

In some implementations, the at least one additional S-SSB may be transmitted in an unlicensed band.

In another aspect of the present disclosure, the processor 412 of the communication apparatus 410 may trigger a sidelink (SL) consistent listen before talk (LBT) (C-LBT) failure in an event that a plurality of SL LBT failures have occurred in an active RB set and select another RB set in which the SL C-LBT failure has not been triggered.

In some implementations, the processor 412 or the physical entity/layer the processor 412 may determine at least one of the SL LBT failures per active RB set.

In some implementations, the at least one of the SL LBT failures or the SL C-LBT failure may be applied to all links of the communication apparatus 410.

In some implementations, the processor 412 or the MAC entity/layer of the processor 412 may transmit information of an RB set that the SL C-LBT failure was detected to the physical entity/layer of the processor 412.

In some implementations, the processor 412 may perform resource exclusion for an RB set that the SL C-LBT failure was detected in a candidate resource selection or a resource pool selection or reselection.

In some implementations, the resource exclusion may be performed by the physical layer of the communication apparatus 410.

In some implementations, the processor 412 may trigger an a RLF procedure for one or more uni-cast (UC) connections in an event that the SL C-LBT failure has been triggered in all RB sets within an SL BWP.

In some implementations, the processor 412 may perform a resource pool selection or reselection in an event that the SL C-LBT failure was detected for all RB sets within a selected resource pool.

In some implementations, the SL C-LBT failure may be triggered by a MAC entity of the processor 412, and the MAC entity may start a timer in an event that the SL LBT failure is detected, increase an LBT counter in an event that consistent SL LBT failure is detected, determine whether the LBT counter reaches a threshold value and determine an SL C-LBT failure event in an event that the LBT counter reaches the threshold value before the timer expires.

In some implementations, the MAC entity may reset the LBT counter for SL C-LBT failure cancellation in an event that the timer is expired.

In some implementations, the MAC entity may reset the LBT counter for SL C-LBT failure cancellation in an event that the timer or the threshold value is reconfigured.

### Illustrative Processes

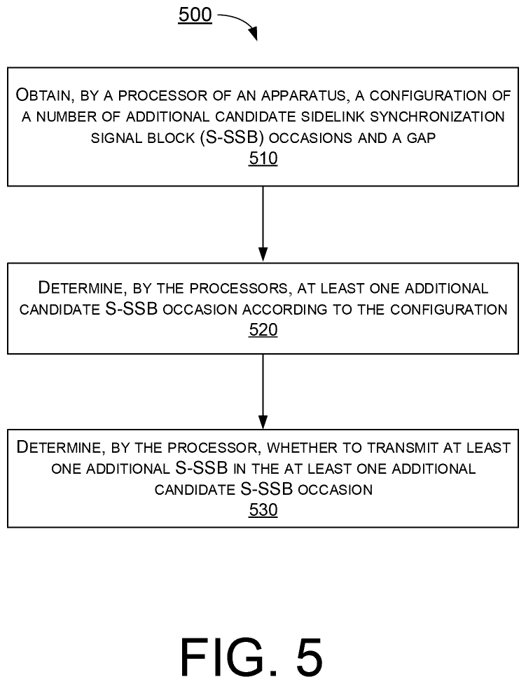

FIG. 5 illustrates an example process 500 in accordance with an implementation of the present disclosure. The process 500 may be an example implementation of above scenarios/schemes, whether partially or completely, with respect to synchronization signal transmission in accordance with the present disclosure. The process 500 may represent an aspect of implementation of features of the communication apparatus 410. The process 500 may include one or more operations, actions, or functions as illustrated by one or more of blocks 510, 520 and 530. Although illustrated as discrete blocks, various blocks of the process 500 may be divided into additional blocks, combined into fewer blocks, or eliminated, depending on the desired implementation. Moreover, the blocks of the process 500 may be executed in the order shown in FIG. 5 or, alternatively, in a different order. The process 500 may be implemented by the communication apparatus 410 or any suitable UE or machine type devices. Solely for illustrative purposes and without limitation, the process 500 is described below in the context of the communication apparatus 410. The process 500 may begin at block 510.

At 510, the process 500 may involve the processor 412 of the communication apparatus 410 obtaining a configuration of a number of additional candidate S-SSB occasions and a gap. The process 500 may proceed from 510 to 520.

At 520, the process 500 may involve the processor 412 determining at least one additional candidate S-SSB occasion according to the configuration. The process 500 may proceed from 520 to 530.

At 530, the process 500 may involve the processor 412 determining whether to transmit at least one additional S-SSB in the at least one additional candidate S-SSB occasion.

In some implementations, the gap may indicate a first gap between an S-SSB slot and a first additional candidate S-SSB occasion or a second gap between two adjacent additional candidate S-SSB occasions.

In some implementations, the process 500 may involve the processor 412 transmitting information regarding the at least one additional candidate S-SSB occasion to a peer apparatus.

In some implementations, the at least one additional SSB may be transmitted in an event that no S-SSB is transmitted in the S-SSB slot or an LBT failure occurs.

In some implementations, the at least one additional SSB may be transmitted in an event that an S-SSB is transmitted in the S-SSB slot or an LBT success occurs.

In some implementations, the number of additional candidate S-SSB occasions and the gap may be configured per SL-BWP.

In some implementations, the number of additional candidate S-SSB occasions may be determined from a predefined set of values.

In some implementations, the gap may be determined from a predefined number of slots.

In some implementations, the second gap may be equal to the first gap.

In some implementations, the number of additional candidate S-SSB occasions may be configured per S-SSB period.

In some implementations, the at least one additional S-SSB may be transmitted in an unlicensed band.

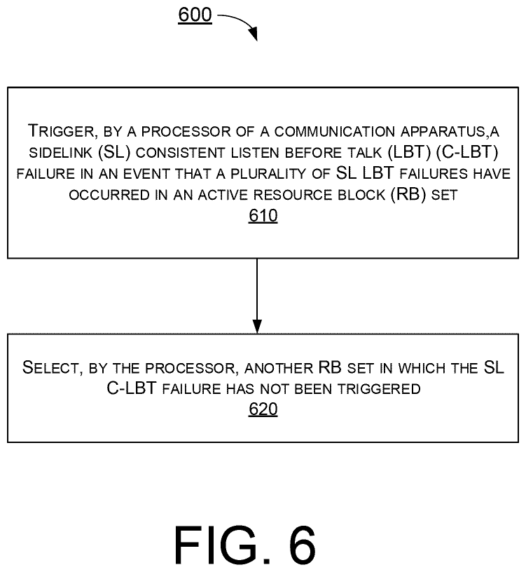

FIG. 6 depicting an example process 600 in accordance with an implementation of the present disclosure. The process 600 may be an example implementation of above scenarios/schemes, whether partially or completely, with respect to LBT failure indication of SL-U in accordance with the present disclosure. The process 600 may represent an aspect of implementation of features of the communication apparatus 410. The process 600 may include one or more operations, actions, or functions as illustrated by one or more of blocks 610 and 620. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the communication apparatus 410 or any suitable UE or machine type devices. Solely for illustrative purposes and without limitation, the process 600 is described below in the context of the communication apparatus 410. The process 600 may begin at block 610.

At 610, the process 600 may involve the processor 412 of the communication apparatus 410 triggering an SL C-LBT failure in an event that a plurality of SL LBT failures have occurred in an active RB set. The process 600 may proceed from 610 to 620.

At 620, the process 600 may involve the processor 412 selecting another RB set in which the SL C-LBT failure has not been triggered.

In some implementations, the process 600 may involve the processor 412 or a physical entity/layer of the processor 412 determining at least one of the SL LBT failures per active RB set.

In some implementations, the at least one of the SL LBT failures or the SL C-LBT failure may be applied to all links of the communication apparatus 410.

In some implementations, the process 600 may involve a MAC entity/layer of the processor 412 transmitting information of an RB set that the SL C-LBT failure was detected to the physical entity/layer of the processor 412.

In some implementations, the process 600 may involve the processor 412 performing resource exclusion for an RB set that the SL C-LBT failure was detected in a candidate resource selection or a resource pool selection or reselection.

In some implementations, the resource exclusion may be performed by a physical layer of the communication apparatus 410.

In some implementations, the process 600 may involve the processor 412 triggering an a RLF procedure for one or more uni-cast (UC) connections in an event that the SL C-LBT failure has been triggered in all RB sets within an SL BWP.

In some implementations, the process 600 may involve the processor 412 performing a resource pool selection or reselection in an event that the SL C-LBT failure was detected for all RB sets within a selected resource pool.

In some implementations, the SL C-LBT failure may be triggered by a MAC entity of the processor 412, and the process 600 may involve the MAC entity starting a timer in an event that the SL LBT failure is detected, increasing an LBT counter in an event that consistent SL LBT failure is detected, determining whether the LBT counter reaches a threshold value and determining an SL C-LBT failure event in an event that the LBT counter reaches the threshold value before the timer expires.

In some implementations, the process 600 may involve the MAC entity resetting the LBT counter for SL C-LBT failure cancellation in an event that the timer is expired.

In some implementations the process 600 may involve the MAC entity resetting the LBT counter for SL C-LBT failure cancellation in an event that the timer or the threshold value is reconfigured.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
obtaining, by a processor of an apparatus, a configuration of a number of additional candidate sidelink synchronization signal block (S-SSB) occasions and a gap;
determining, by the processor, at least one additional candidate S-SSB occasion according to the configuration; and
determining, by the processor, whether to transmit at least one additional S-SSB in the at least one additional candidate S-SSB occasion.

2. The method of claim 1, wherein the gap indicates a first gap between an S-SSB slot and a first additional candidate S-SSB occasion or a second gap between two adjacent additional candidate S-SSB occasions.

3. The method of claim 1, wherein the at least one additional S-SSB is transmitted in an event that no S-SSB is transmitted in an S-SSB slot or a listen before talk (LBT) failure occurs.

4. The method of claim 1, wherein the at least one additional S-SSB is transmitted in an event that an S-SSB is transmitted in an S-SSB slot or a listen before talk (LBT) success occurs.

5. The method of claim 1, wherein the number of additional candidate S-SSB occasions and the gap are configured per sidelink bandwidth part (SL-BWP).

6. The method of claim 1, wherein a number of additional candidate S-SSB occasions is determined from a predefined set of values.

7. The method of claim 1, wherein the gap is determined from a predefined number of slots.

8. The method of claim 2, wherein the second gap is equal to the first gap.

9. The method of claim 1, wherein the at least one additional S-SSB is transmitted in an unlicensed band.

10. A method, comprising:
triggering, by a processor of an apparatus, a sidelink (SL) consistent listen before talk (LBT) (C-LBT) failure in an event that a plurality of SL LBT failures have occurred in an active resource block (RB) set; and
selecting, by the processor, another RB set in which the SL C-LBT failure has not been triggered.

11. The method of claim 10, further comprising:
determining, by a physical layer of the processor, at least one of the SL LBT failures per active RB set.

12. The method of claim 11, wherein the at least one of the SL LBT failures or the SL C-LBT failure is applied to all links of the apparatus.

13. The method of claim 10, further comprising:
transmitting, by a medium access control (MAC) layer of the processor, information of an RB set that the SL C-LBT failure was detected to a physical layer of the processor.

14. The method of claim 10, further comprising:
performing, by the processor, resource exclusion for an RB set that the SL C-LBT failure was detected in a candidate resource selection or a resource pool selection or reselection.

15. The method of claim 14, wherein the resource exclusion is performed by a physical layer of the apparatus.

16. The method of claim 10, further comprising:
triggering, by the processor, a radio link failure (RLF) procedure for one or more uni-cast (UC) connections in an event that the SL C-LBT failure has been triggered in all RB sets within a SL bandwidth part (BWP).

17. The method of claim 10, further comprising:
performing, by the processor, a resource pool selection or reselection in an event that the SL C-LBT failure was detected for all RB sets within a selected resource pool.

18. The method of claim 10, wherein the SL C-LBT failure is triggered by a medium access control (MAC) entity of the processor, and the method further comprises:
starting, by the MAC entity, a timer in an event that the SL LBT failure is detected;
increasing, by the MAC entity, an LBT counter in an event that consistent SL LBT failure is detected;
determining, by the MAC entity, whether the LBT counter reaches a threshold value; and
determining, by the MAC entity, an SL C-LBT failure event in an event that the LBT counter reaches the threshold value before the timer expires.

19. The method of claim 18, further comprising:
resetting, by the MAC entity, the LBT counter for SL C-LBT failure cancellation in an event that the timer is expired.

20. The method of claim 18, further comprising:
resetting, by the MAC entity, the LBT counter for SL C-LBT failure cancellation in an event that the timer or the threshold value is reconfigured.
